(19) United States
(12) Patent Application Publication
(10) Pub. No.: US 2008/0064324 A1
(43) Pub. Date: Mar. 13, 2008

(54) SATELLITE DATA MESSAGING SYSTEM WITH RADIO CHANNEL HYPERLINKING

(75) Inventor: Axel Nix, Birmingham, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/466,899

(22) Filed: Aug. 24, 2006

(51) Int. Cl. H04H 1/00; G08G 1/123

(52) U.S. Cl. 455/3.02; 340/988; 340/539.13; 455/427; 340/7.48

(57) ABSTRACT

A data messaging system includes a satellite radio receiver configured to receive a message including a message identifier and two or more filter criteria and to process the message to generate a processed message according to the message identifier and the two or more filter criteria. A telematic unit is coupled to the satellite radio receiver. The telematic unit is configured to provide positional data to the satellite radio receiver. A body control module is also coupled to the satellite radio receiver. The body control module is configured to provide vehicle information to the satellite radio receiver. A display, coupled to the satellite radio receiver, is configured to display the processed message.

### TECHNICAL FIELD

The present invention relates to the field of vehicular communication and, more specifically, to a satellite data messaging system with radio channel hyperlinking.

### BACKGROUND OF THE INVENTION

Satellite radio systems receive signals broadcasted from a satellite or, in some systems, from a satellite via terrestrial repeaters. Current satellite radio systems can receive messages specifically sent to the satellite radio systems. For example, stock data, sports scores and weather data can be sent to satellite radio systems as text or graphical messages that can be shown on the display of the satellite radio receiver.

While the ability to send messages to a satellite radio system provides a useful way of sending information, current messaging schemes lack the ability to efficiently process and filter messages.

Accordingly, it is desired to provide an improved satellite data messaging system with radio channel hyperlinking. Furthermore, the desirable features and characteristics of the present invention will be apparent from the subsequent detailed description and the appended claims, taken in conjunction with the accompanying drawings and the foregoing technical field and background.

### SUMMARY OF THE INVENTION

In one embodiment of the present invention, a satellite radio messaging system includes a satellite radio receiver configured to receive a message including a message identifier and a filter criteria, and to process the message to generate a processed message according to the message identification and the filter criteria. A display coupled to the satellite radio receiver is configured to display the processed message.

In another embodiment, a method for receiving messages at a satellite radio includes receiving a message and determining a message ID of the message. The system then determines whether the message ID is greater than a last received message ID. If the message ID is greater than the last received message ID the message is filtered based on a first filtering criteria to determine a displayable message, then the displayable message is displayed.

In another embodiment, a data messaging system includes a satellite radio receiver configured to receive a message including a message identifier and two or more filter criteria and to process the message to generate a processed message according to the message identifier and the two or more filter criteria. A telematic unit is coupled to the satellite radio receiver. The telematic unit is configured to provide positional data to the satellite radio receiver. The body control module is also coupled to the satellite radio receiver. The body control module is configured to provide vehicle information to the satellite radio receiver. A display, coupled to the satellite radio receiver, is configured to display the processed message.

### DESCRIPTION OF THE DRAWINGS

The present invention will hereinafter be described in conjunction with the following drawing figures, wherein like numerals denote like elements, and:

FIG. 1 is a block diagram of a satellite radio messaging system in accordance with an exemplary embodiment of the present invention;

FIG. 2 is a block diagram of an exemplary message packet in accordance with an exemplary embodiment of the present invention; and

FIG. 3 illustrates a satellite radio head unit showing a hyperlinked radio channel in accordance with an exemplary embodiment of the present invention.

### DESCRIPTION OF AN EXEMPLARY EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

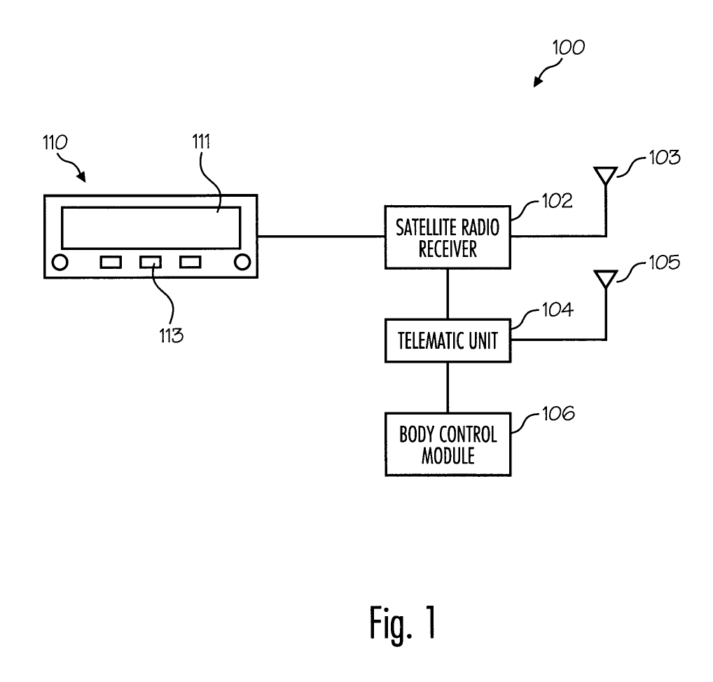

FIG. 1 is a block diagram of an exemplary embodiment of a satellite messaging system 100. The satellite messaging system 100 receives, filters and displays messages sent from or routed through a satellite based broadcast system. In one exemplary embodiment, satellite messaging system 100 comprises a satellite radio receiver 102, a telematic unit 104, and a body control module 106, each of which are coupled together by a vehicular local area network connection 108. A radio head unit 110 is also coupled to the vehicular local area network connection 108.

Satellite radio receiver 102 receives satellite broadcasts either directly from a satellite or indirectly from a satellite via one or more terrestrial repeaters using radio antenna 103. Satellite radio receiver 102 typically receives audio broadcasts but, as discussed previously, may also receive text messages, graphical data, video data and the like. In one exemplary embodiment, the satellite radio receiver 102 may also filter received messages, rejecting messages not meant for the particular satellite radio receiver 102.

Telematic unit 104 integrates telecommunication systems, such as cellular telephony systems, with other systems such as vehicular location systems (GPS navigation information). Telematic unit 104 is coupled to telematic antenna 105. In one exemplary embodiment, telematic unit 104 provides data to the satellite radio receiver 102 for use in filtering messages. For example, the telematic unit 104 can provide the location of the vehicle to the satellite radio receiver 102 in order to provide for message filtering via locational data. The OnStar® system by General Motors Corporation is an example of such a telematic system.

Body control module 106 contains information regarding the particular vehicle in which the body control module 106 is installed. In one exemplary embodiment, the body control module 106 can provide information to the satellite radio receiver 102 for use in filtering messages. In one exemplary embodiment, data such as the vehicle identification number (VIN) can be sent to the satellite radio receiver 102 for use in filtering messages.

Radio head unit 110 includes a display screen 111 and controls 113 for the satellite radio receiver 102. The display screen 111, in one exemplary embodiment, provides an area of radio information such as the channel to which the satellite radio receiver 102 is tuned, the name of the artist, and the title of the song. In another exemplary embodiment, messages sent to the satellite radio receiver 102 can be viewed on display screen 111 by a user.

Controls 113 provide an interface for the user to control the operation of the satellite radio receiver 102. In one exemplary embodiment, controls 113 allow the user to change radio channels, control the volume, and the like. In another embodiment, controls 113 can be used in conjunction with a displayed message to tune the satellite radio receiver 102 to a specific radio channel for more information, to request more information than is contained in a displayed message, and the like. Controls 113 can be physical controls or can be simulated on a touch screen display.

Vehicular local area network 108 couples the various components of the satellite messaging system 100 together and allows data to be sent between the various components of the satellite messaging system 100. Vehicular local area network 108 may be any wired or wireless connection or a combination thereof.

While FIG. 1 illustrates the satellite radio receiver 102, telematic unit 104 and body control module 106 as individual units, their functionalities can be combined. For example, the satellite radio receiver 102 can be integrated as part of the radio head unit 110 or the thematic unit 104.

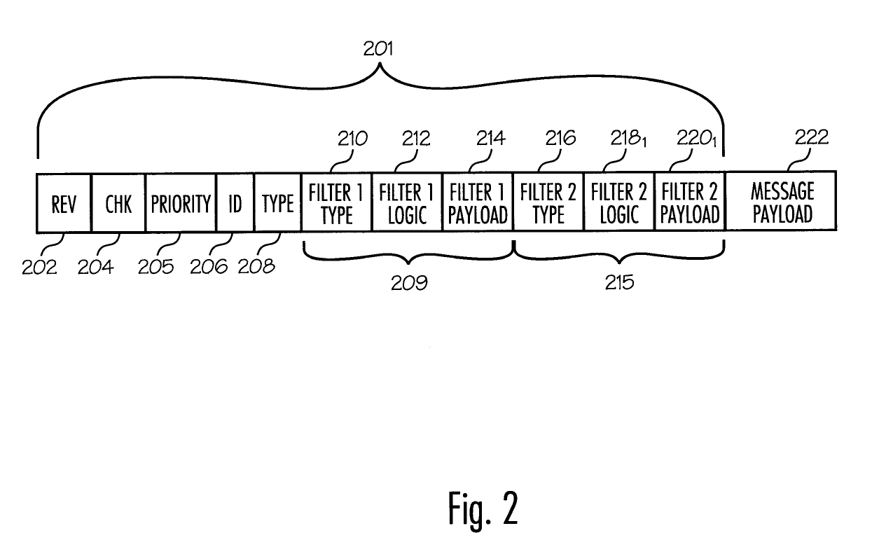

FIG. 2 is an exemplary embodiment of a message 200 received by satellite radio receiver 102. Message 200 includes a header section 201 and a message payload section 222. Header section 201 may include a message revision number 202, a continuous check flag 204, a priority ID 205, a message ID 206, a message type 208, a first filter 207, and a second filter 215. Messages 200, in one exemplary embodiment, are continuously broadcasted. Since not all vehicles are operating at the same time, different vehicles will receive messages 200 at different times. This requires message 200 to be rebroadcast until it is likely that all vehicles have received the message 200. Alternatively, message 200 may stop being broadcasted once the message is outdated or no longer relevant. The frequency of rebroadcast can different depending on the importance of the message 200 or other factors.

Message revision number 202 identifies a messaging protocol revision level. In one exemplary embodiment, the satellite radio receiver 102 discards any messages with a message revision number 202 higher than the highest message revision number 202 supported by the satellite radio receiver's 102 software.

The continuous check flag 204 identifies message 200 as one of two types: messages that need to be processed only once, and messages that need to be processed each time they are received. Messages 200 that need to be processed only once can be disregarded during any rebroadcasts once they are processed. In one exemplary embodiment, these single processed messages may be identified by a “0” bit in the continuous check flag 204. Messages 200 that need to be processed only once include messages where changes in the vehicle, such as a change in location, do not cause different filters to apply. The filtering of messages, including messages that need to be processed only once, is discussed in greater detail below.

Messages 200 that need to be processed every time they are received include messages 200 that have filtering criteria whose evaluation may have changed since the broadcast cycle. This may include messages that are sent to specific geographical regions. In one exemplary embodiment, messages in this group are identified by a “1” bit in the continuous check flag 204.

In one exemplary embodiment, each message 200 may be identified by a unique combination of the message priority ID 205 and the message ID 206. The message priority ID 205 allows the importance of a message 200 to be set such that it can be processed in accordance with the set priority. Priorities may include, for example, low priority, low to middle priority, middle to high priority, and high priority.

In one exemplary embodiment, message IDs 206 are assigned in sequential order. Messages 200 may then be broadcasted sequentially, starting from the lowest active message ID 206 to the highest active message ID 206.

For messages 200 that only need to be processed once, the satellite radio receiver 102 may maintain one pointer per message priority ID 205 to store the message ID 206 corresponding to the highest message ID 206 that has already been received and processed for a particular priority. In embodiments where there are four priority levels, there are a total of four pointers. The satellite radio receiver 102 may disregard any messages 200 having a message ID 206 lower than the message ID 206 stored in its internal pointer for the given priority. Once a new message is processed, the satellite radio receiver 102 updates its pointer to be the message ID 206 of the message 200 it has just processed.

For messages 200 that need to be processed only once, the satellite radio receiver 102 can process new messages 200 sequentially. When the satellite radio receiver 102 is first started, such as by starting the vehicle, it is unknown where within the broadcast cycle the satellite radio receiver 102 starts to receive messages. Therefore, special handling of the initialization phase is desirable.

For example, after start-up, if the satellite radio receiver 102 receives a message ID 206 lower than its pointer in the respective priority, the satellite radio receiver 102 may resume normal operation and process any new messages 200 with a message ID 206 higher than the pointer value in the order they are received.

If, on the other hand, after start-up, the satellite radio receiver 102 receives a first message ID 206 higher than its internal pointer, the satellite radio receiver 102 may temporarily store the newly received message ID 206 and delay processing of any new messages 200 until a message 200 with a message ID 206 lower than or the same as the temporarily stored message ID 206 is received. In an exemplary embodiment, the messages are broadcasted sequentially with an increasing message IDs 206 (until a message repeats).

For messages 200 that need to be processed continuously (messages whose continuous check flag 204 is “1”), the satellite radio receiver 102 may maintain a list of processed messages that it has already processed. In one exemplary embodiment, the list of processed messages may contain up to 32 unique messages IDs 206. In this exemplary embodiment, if the list of processed messages is full, any new check messages may be disregarded. If the processed messages list contains less than 32 entries, each newly received continuously processed message ID 206 that is not in the processed messages list may be processed. If the message applies (e.g., it passes one or more filter criteria) it may be queued for display and its message ID 206 may be added to the processed messages list. A continuously processed message whose message ID 206 is already in the processed messages list may be disregarded.

For messages that need to be continuously checked, the satellite radio receiver 102 may continuously check its processed messages list against all messages 200 it receives. If the satellite radio receiver 102 during one complete and uninterrupted broadcast cycle did not re-receive a message ID 206 found in its processed messages list, the message ID 206 may be removed from the processed messages list. To simplify detection of broadcast cycles the satellite broadcast can include four permanent system synchronization messages, each using a unique message ID 206, with one synchronization message used for each type of priority. A broadcast cycle for a given priority is completed every time the message priority is received.

Each message 200, in one exemplary embodiment, may also contain a message type 208. The message type 208 can allow customers to filter messages based on preferences. Messages type 208 may include disaster messages, AMBER alert messages (government sanctioned messages regarding missing or endangered children), traffic messages, weather messages, vehicle tip messages (which can include vehicular specific tips), campaign reminders (which can include recall information), reminder messages (which can include reminders regarding maintenance) and advertising messages. A user could require that all vehicle tip information be suppressed and not displayed.

Message 200 may include a first filter 207 and a second filter 215. In the present invention, message 200 can be targeted to selected vehicles. The targeting of message 200 is made possible by applying filters to each message 200 and only displaying those messages 200 that pass the filter criteria. Providing multiple filters allows for a more robust filtering scheme than a single filter would provide.

Typically, in an exemplary embodiment, each message 200 contains two filters 207, 215, each of which include three filter components: (a) a filter type 210, 216, which determines how to interpret the filter payload, (b) a filter logic 212, 218, which determines how to apply the filter, and (c) a filter payload 214, 220, which contains the filter content.

Filter logic 212, 218 may include Boolean logic statements such as AND, OR, NOT, and XOR. In the present invention, filter logic 212, 218 allows inverting filters (e.g., address all vehicles of a certain model or address all vehicles except a certain mode) and combining two filters flexibly (e.g., address all vehicle models that don't have a navigation system).

The filter type 210, 216 provides information regarding how to interpret the filter payload 214, 220. In one embodiment, the following filter types 210, 216 are used: VIN filter, region code filter, location filter, and group filter. The satellite radio receiver 102 may discard any messages 200 containing an unknown filter type.

VIN numbering filtering uses the VIN number from a vehicle to determine if a message is intended for the vehicle. As discussed previously, the body control module 106 can provide the VIN number to the satellite radio receiver 102 for filtering purposes. When VIN number filtering is used, the filter payload 214, 220 can be a VIN number or a range of VIN numbers.

Region code filtering is based on assigning a numeric code to each region, county, or city. The region code, in one exemplary embodiment, is a binary value that is calculated in the telematics unit 104 based on its GPS latitude/longitude information and using a lookup table containing region codes and regional geometries (county or city borders). In one exemplary embodiment, the lookup table is structured such that regions are locally clustered and region codes can be used hierarchically, although other methods of implementing region numbering can also be used.

For example, all states in the Western U.S. may be assigned a “1” bit in their most significant region code bit while all states in the Eastern U.S. may be assigned a “0” bit. All states in the Northern U.S. may be assigned a “0” bit while all states in the Southern U.S. may be assigned a “1” in bit 2. Subsequent bits divide the resulting states further until each state is assigned a unique bit sequence. Following the same logic each state is divided into several counties and counties can be further divided into cities.

In this exemplary embodiment, if a region code filter is selected, the filter payload 214, 220 contains two filter bits for each region code bit, identifying whether the region code bit is “0”, “1”, “d”, or “e”. If the filter payload 214, 220 contains a “0” bit in the first two bits it indicates that the message only applies to vehicles that are in a region where the first bit is “0” as well—i.e. only vehicles in the Eastern U.S. If the filter payload contains a “d” (“don't care”) the message applies to vehicles in both the Eastern and Western U.S., with the next bits providing more detailed coverage information. An “e” in the filter payload 214, 220 indicates the last two bits, allowing for flexible width filter payloads. Thus, an “11e” filter payload indicates the messages 200 that apply to all of the Southwestern U.S. (based on the lookup table) while (“00101010010101110110101e”) might refer to a specific county in the Northeastern U.S. Region filtering can also be done by specifying a rectangle or other shape defined by GPS coordinates. In this manner, messages can be sent to vehicles in a defined region.

While region or VIN based filters cover a large number of possible groupings of vehicles they are not exhaustive. In some cases it is desirable to address groups of vehicles with common characteristics that aren't covered by existing in-vehicle information. To address those needs, vehicles can be assigned to groups. When the vehicle is manufactured the group membership identification can be written into the telematics unit 104 in the form of a group membership string, which can be used to filter group based messages. The group membership string can be dynamically updated using the telematic unit's 104 cell phone connection.

A possible group of vehicles is, for example, “all vehicles equipped with a navigation system.” Messages containing tips on how to use the features of the navigation system can be sent to those vehicles. While group membership can be assigned at the time the vehicle is built, other group memberships are typically programmed after the vehicle is built. For example, the time of warranty expiration, which is known only after the vehicle has been sold. The satellite radio receiver 102 may support up to 32 group membership filters.

The message payload section 222 can be, in one exemplary embodiment, formed using ASCII text. The message payload section 222 may also support HTML style tags as defined below. The message payload section 222 may contain the same content optimized for different width displays.

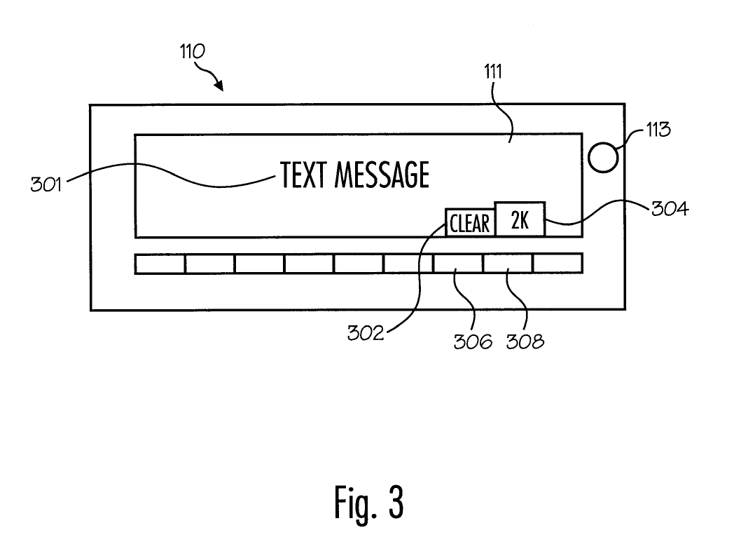

In another embodiment of the invention, the messages 200 may also include a “hyperlink”. Similar to the use of hyperlinks on websites that refer to other websites, satellite radio delivered text messages can contain hyperlinks to satellite radio channels when additional information is needed. FIG. 3 illustrates the radio head unit 110 with a display 111 that can show a text message 301. The text message 301 includes a clear indicator 302 and a station hyperlink 304. The clear indicator 302 is associated with a first button 306 and a second button 308. Selecting the first button 306 clears the text message 301 and selecting the second button 308 tunes the satellite radio receiver 102 to the station displayed as the station hyperlink 304.

For example, a message could read “Chemical plant explosion. Listen on Channel 216.” Depending on the user interface “Channel 216” could be displayed as a virtual button on a touch screen, such as a touch screen for a navigation system, or as a physical control 113 in a radio head unit 110. In addition to providing a link to a satellite radio channel, a hyperlink could also be provided to a cellular phone number, a telematic system call center, or any other service system.

The satellite messaging system 100 as described previously is text based and may provide hyperlinks to radio channels where live broadcasts may provide additional information about an alert or hyperlinks that through a cellular phone connection can provide more information. In some instances, it is however desirable to have non-urgent messages provided as audio without interrupting the program the driver is listening to. To provide this capability the messaging system can utilize two different concepts: synchronized live audio recording and storage, and audio file download and hyperlinking.

The synchronized live recording concept utilizes a live XM audio broadcast like any regular satellite radio channel. However, the messaging channel and the live audio broadcast are used in a cooperative manner to allow a satellite radio receiver 102 to automatically record audio broadcasts relating to a specific message. This recording embodiment applies to the satellite radio receiver 102 with integrated mass storage such as hard disk drives or flash memory. To enable synchronized recording, the message type 208 is selected to indicate that a corresponding audio broadcast is available. The radio then looks for a particular satellite radio broadcast, which is identified by a data field synchronously broadcasted with its audio; just like is done with song titles, artist names, etc. The data field is preferably populated with the same message ID 206 used in the message 200 broadcast to satellite radio receiver 102 in order to correlate the message with the received content.

If the satellite radio receiver 102 detects that a message 200 is relevant and that an audio broadcast exists, the satellite radio receiver 102 starts looking for the matching message ID 206 on the audio broadcast channel and starts recording as soon as the corresponding audio starts and stops recording when the corresponding audio ends. The audio recording is stored in the radio until it either expires or is deleted. In one exemplary embodiment, recorded messages automatically expire if they are no longer broadcasted.

An alternative concept is based on a continuous file download channel synchronized with the messaging channel. File downloads can be used for many different applications and include different files types, e.g., video files, audio files, and the like. The file download can be coordinated with the messaging application so that messages link to audio files stored in the flash memory or hard disk drive of the satellite radio receiver 102. To establish the correlation between messages and stored content, the satellite messaging system 100 may use file names including the unique message ID 206 described previously. The message might include a hyperlink to the downloaded content.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A satellite radio messaging system comprising:
a satellite radio receiver configured to receive a message including a message identifier and a filter criteria and to process the message to generate a processed message according to the message identifier and the filter criteria; and
a display coupled to the satellite radio receiver and configured to display the processed message.

2. The messaging system of claim 1, wherein a telematic unit is coupled to the satellite radio receiver and configured to provide location information to the satellite radio receiver.

3. The messaging system of claim 2, wherein a body control module is coupled to the satellite radio receiver and configured to provide vehicular information to the satellite radio receiver.

4. The messaging system of claim 1, wherein the filter criteria is based on a vehicle identification number.

5. The messaging system of claim 1, wherein the filter criteria is based on a regional code, the regional code based on locally clustered regions.

6. The messaging system of claim 1, wherein the filter criteria is based on a GPS location.

7. The messaging system of claim 1, wherein the satellite radio receiver receives a message comprising multiple filter criteria.

8. The messaging system of claim 1 wherein the display is further configured to display a hyperlink to a radio channel with the processed message.

9. The messaging system of claim 1 wherein the message identifier includes a message identification number and a message priority.

10. A method for receiving messages at a satellite radio comprising:
receiving a message;
determining a message ID of the message;
determining if the message ID is greater than a last received message ID;
filtering the message to determine a displayable message based on a first filtering criteria if the message ID is greater than the last received message ID; and
displaying the displayable message.

11. The method of claim 10, wherein the step of filtering the message further comprises the step of filtering the message based on the first filtering criteria and a second filtering criteria.

12. The method of claim 11, wherein the step of filtering the message further comprises filtering the message based on the vehicle identification number.

13. The method of claim 11, wherein the step of filtering the message further comprises filtering the message based on the vehicle location.

14. The method of claim 11, wherein the step of filtering the message further comprises filtering the message based on the GPS defined area.

15. The method of claim 11, further comprising evaluating the first filtering criteria and the second filtering criteria using Boolean algebra.

16. The method of claim 13, further comprising receiving location data from the telematic unit to determine the location data to filter the message.

17. The method of claim 12, further comprising receiving a vehicle identification number from a body control module to be used to filter the message.

18. The method of claim 10, further comprising displaying a hyperlink in the display, and turning to a specific channel of the satellite radio upon selection of the hyperlink.

19. A data messaging system comprising:
a satellite radio receiver configured to:
receive a message including a message identifier and two or more filter criteria; and
process the message to generate a processed message according to the message identifier and the filter criteria;
a telematic unit coupled to the satellite radio receiver, the telematic unit configured to provide positional data to the satellite radio receiver;
a body control module coupled to the satellite radio receiver, the body control module configured to provide vehicle information to the satellite radio receiver; and
a display configured to display the processed message.

20. The system of claim 19 wherein the satellite radio receiver receives a hyperlink associated with the message, the hyperlink displayable on the display, the hyperlink, when selected, tuning the satellite radio to a channel that provides audio information related to the message.
